(19) United States
(12) Patent Application Publication
(10) Pub. No.: US 2008/0303855 A1
(43) Pub. Date: Dec. 11, 2008

(54) Compliant Sealing Materials and Methods For Sealing Nozzles For A Micro-Fluid Ejection Head

(76) Inventors: Alan Bidwell, Lexington, KY (US); Girish Shivaji Patil, Lexington, KY (US); Tu Phan, Lexington, KY (US); Kirk Lawrence Stechschulte, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/759,278

(22) Filed: Jun. 7, 2007

(51) Int. Cl. B41J 2/015; F16J 15/02

(52) U.S. Cl. 347/20; 277/314; 277/627

(57) ABSTRACT

A compliant sealing structure suitable for sealing a micro-fluid ejection head, methods of sealing a micro-fluid ejection head, ejection heads sealed by the method and structure. The sealing structure includes an elastomeric pad suitable for sealing nozzles of the micro-fluid ejection head. A removable shrink wrap film is applied to the ejection bead and is configured for covering at least a portion of the elastomeric pad and for fixedly holding the elastomeric pad adjacent the nozzles.

### TECHNICAL FIELD

The disclosure relates to nozzle sealing apparatus and to methods for protecting micro-fluid ejection heads during shipment and storage.

### BACKGROUND AND SUMMARY

The present disclosure relates to protecting and/or sealing of nozzles 100 in a nozzle area 102 of a micro-fluid ejection head 104 for the purposes of storing and/or shipping of the ejection head 104 and/or a cartridge body 106 containing the ejection head 104. A schematic depiction of a conventional micro-fluid ejection head 104 and cartridge body 106 is shown in FIG. 1. A major problem in maintaining a robust seal on such a device is the highly demanding and sometimes conflicting requirements for such an application. For example, a sealant material must completely cover the nozzles 100, thereby preventing fluid from leaking out of the nozzles 100 for the entire “shelf life” of the ejection head 104. In addition, the sealant material must be compatible with the fluid contained within the ejection head 104 or cartridge body 106. Ideally, the sealant material should not alter the properties of the fluid and it should not dissolve or appreciably swell when in contact with the fluid. The fluid should also not interfere with the ability of the sealant material to adhere to the surface of the ejection head 104.

The sealant should also provide a physical barrier that not only prevents intermixing and/or contamination with other fluids and/or the external environment, it should prevent evaporation of any volatile components within the fluid sealed in the ejection head 104. Also, the sealant material should remove cleanly from the ejection head 104 leaving a minimum amount or essential no residue on the ejection head 104 and nozzles 100 so as to not affect fluid ejection (via misdirection or missing droplets, for example).

Conventionally, the primary sealant material has been an acrylate-based pressure sensitive adhesive (“PSA”) tape 108, an example of which is shown in FIG. 1. However, as the size of the ejection head nozzles has decreased and the complexity of the fluid components has grown with each new generation of printers, the ability of the PSA tape 108 to meet the application requirements has diminished drastically.

To better understand the challenges of using a PSA tape for this type of application, a description of how a PSA tape works is provided. An example of a PSA tape is provided in U.S. Pat. No. 4,181,752. Typically, PSA tapes are copolymers of a major proportion of alkyl esters of acrylic acid (the alkyl group containing from about four to fourteen carbon atoms) and a minor proportion of at least one “modifying monomer” (also referred to as an adhesion promoter) such as acrylic acid, methacrylic acid, acrylamide, acrylonitrile, methacrylonitrile, N-vinyl pyrrolidinone, maleic anhydride, or itaconic acid. This type of copolymer is effective as a tape due to the soft nature of the polymer which enables efficient and rapid “wetting” of the substrate. Efficient coverage, or wetting, also maximizes surface area coverage and/or interaction between the adhesive tape and substrate. As the degree of coverage increases, the strength of the bond between the two surfaces increases. It is also a common practice to add multifunctional reactants (such as trimethylolpropane triacrylate) during the polymerization of these acrylate and “modifying” monomers. These multifunctional reactants act as crosslinking agents during the polymerization of these adhesive tapes, thereby increasing the molecular weight and cohesive strength of the resulting adhesive tape.

For example, an acrylic adhesive PSA tape is cross-linked to a certain extent (not completely cross-linked) to manage flow properties of the adhesive to be able to wet the nozzle plate and seal the nozzles. Too much cross-linking reduces adhesion resulting in fluid leakage from the ejection head. However, too little cross-linking results in nozzle clogs and residue on the nozzle plate surface. Hence, the amount of cross-linking has to be very delicately balanced to achieve sufficient adhesion while assuring that minimal or no residue is left on the nozzle plate. Nevertheless, “controlled” cross-linking has a propensity to leave behind on the nozzle plate low molecular weight oligomers that are not cross-linked into the adhesive matrix.

From a practical perspective, PSA tapes are classified based on two basic properties: compliance (the ability of the tape to conform to a substrate being adhered to) and cohesive strength (the ability of the tape to resist deformation under load). Compliance comes from the soft nature (low Tg) of the polymer in the adhesive tape while the cohesive strength arises from the crosslink density and molecular weight of the adhesive tape. However, these two properties are generally opposed to one another. For example, if a tape is too firm (resulting from a high crosslink density), its ability to “wet” or comply with the surface being bonded will be lacking. On the other hand, if a tape is too compliant, it will lack the strength necessary to maintain the bond under an applied load. Therefore, a delicate balance is always present when designing a tape for a specific application.

For the case of sealing nozzles of a micro-fluid ejection head, maintaining an acceptable balance of compliance and cohesive strength has proven to be very difficult. It is now commonly observed that a PSA tape, which is sufficiently compliant to seal a micro-fluid ejection bead, typically does not remove cleanly due to a lack of cohesive strength. The exact opposite case has been equally problematic; namely, adhesive tapes that have sufficient cohesive strength (for clean removal) typically do not adequately seal the ejection head due to their lack of compliance. However, since both aspects are equally vital for the overall functional performance of a micro-fluid ejection head sealant, a compromise between these two properties is not an option. Therefore, it has become necessary to investigate more robust sealing options. Such an option is presented in the present disclosure.

In accordance with the disclosure, there is disclosed a compliant sealing structure suitable for sealing a micro-fluid ejection bead. The sealing structure includes an elastomeric pad suitable for sealing nozzles of the micro-fluid ejection head and a removable shrink wrap film configured for covering at least a portion of the elastomeric pad and for fixedly holding the elastomeric pad adjacent the nozzles.

Another embodiment comprises a method of protecting a nozzle area containing nozzles on a micro-fluid ejection head with a removable sealing member. The method includes applying a compliant pad to the nozzle area. A removable shrink wrap film is shrink wrapped to the micro-fluid ejection head and at least a portion of the compliant pad.

Another embodiment comprises a micro-fluid election head having nozzles sealed by a sealing structure that includes an elastomeric pad and a removable shrink wrap film covering at least a portion of the elastomeric pad and fixedly holding the elastomeric pad adjacent the nozzles.

An advantage of the disclosed embodiments is that a sealing structure and method of sealing the nozzle area of an ejection head may be provided that reduces or eliminates inadequate sealing problems and residue problems associated with conventional PSA tape structures commonly used to seal the ejection head nozzles. Additional objects and advantages of the disclosure will be set forth in part in the description which follows, and/or can be learned by practice of the disclosure. The objects and advantages of the disclosure will be realized and attained by means of the elements and combinations particularly pointed out in the appended claims.

It is to be understood that both the foregoing general description and the following detailed description and figures are exemplary and explanatory only and are not restrictive of the disclosure, as claimed.

### BRIEF DESCRIPTION OF THE DRAWINGS

FIG. 1 is a perspective view, not to scale, of a prior art pressure sensitive adhesive tape used for sealing nozzles of a micro-fluid ejection head.

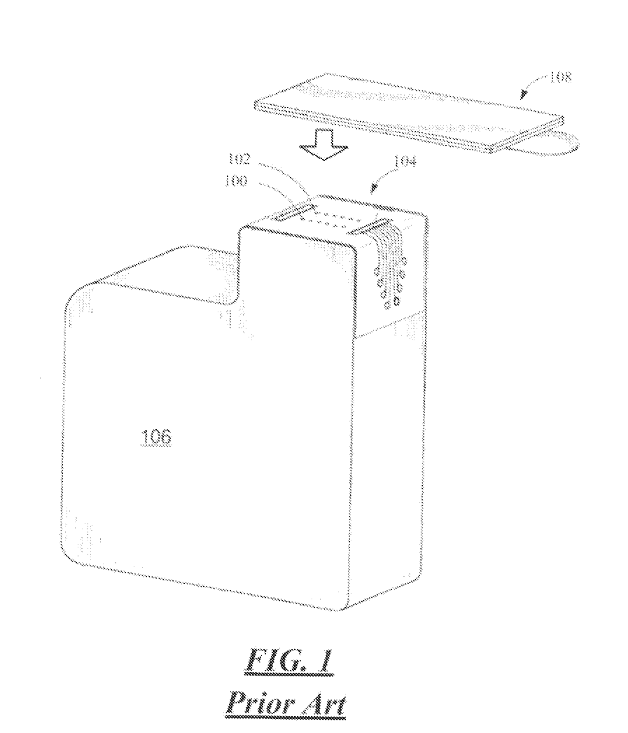

FIGS. 2 and 3 are schematic cross-sectional views, not to scale, of a structure and method of scaling an ejection head according to a first embodiment of the disclosure.

FIGS. 4 and 5 are schematic cross-sectional views, not to scale, of a structure and method of sealing an ejection head according to a second embodiment of the disclosure.

FIG. 6 is a perspective view of a cartridge body containing an ejection head and a structure for sealing a nozzle area of the ejection head according to another embodiment of the disclosure.

### DESCRIPTION OF THE EMBODIMENTS

As will be described in more detail below, the nozzle sealing structure and methods described herein may provide a compliant, solid material that may be forced against the nozzles to form a seal and applies a mechanical sealing force to the nozzle area, without leaving residue such as adhesive residue on the nozzle plate. The mechanical force provided by the shrink wrap film takes the place of the adhesion to the nozzle plate and the compliant material provides a sealing material as an ejection head sealing mechanism in place of the PSA tape 108 described above.

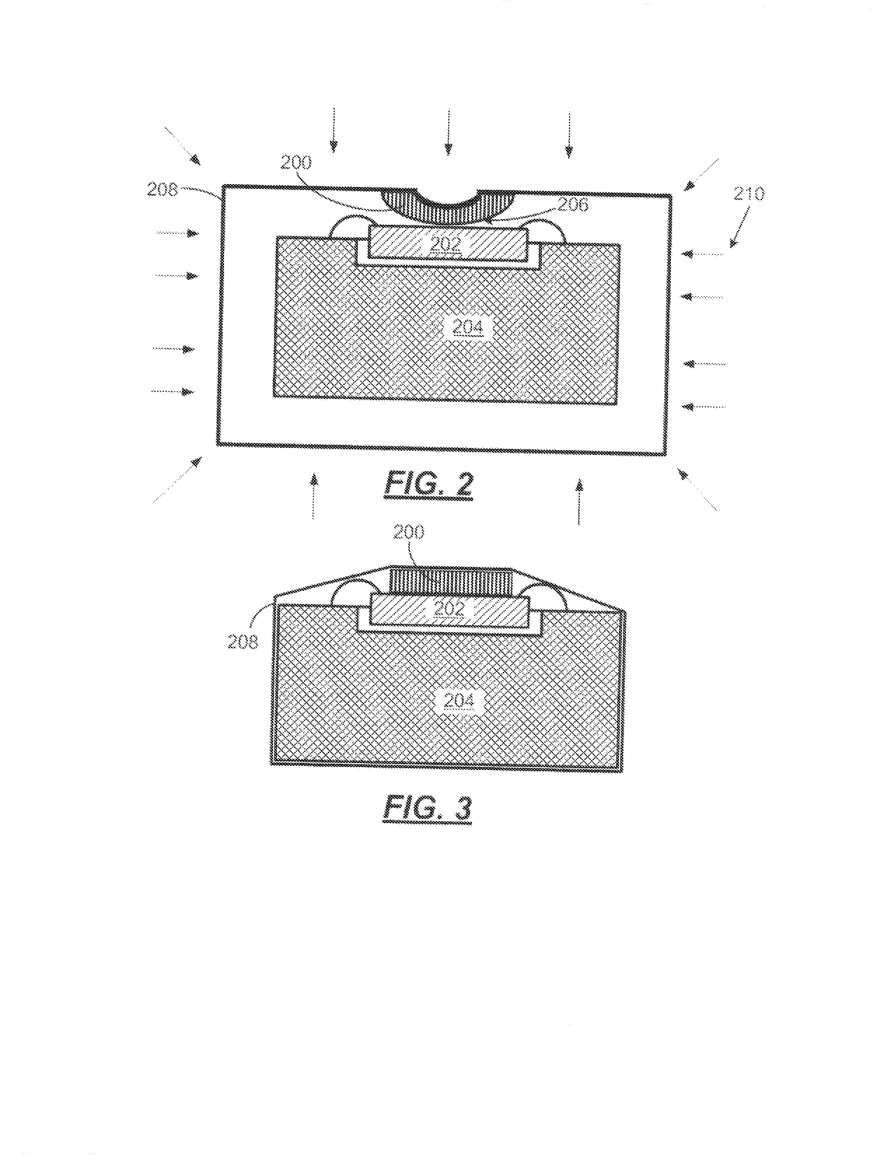

With reference now to FIGS. 2-3, the compliant, solid material 200 may be selected from materials that are suitable for sealing the nozzles of an ejection head 202 with a minimum of force while providing seal integrity during shipping and storing of the ejection head 202 and cartridge body 204. Suitable compliant sealing materials 200 may also be configured to avoid forcing air into nozzles or trapping air adjacent to the nozzles during a nozzle sealing step. Accordingly, in one exemplary embodiment, the compliant material 200 has a dome shape cross-section as shown in FIG. 2 so that a rounded portion 206 of the cross-section of the compliant material 200 is adjacent to the ejection head 202 prior to sealing the nozzles. Upon sealing the nozzles, air adjacent to the nozzles may be pushed to the periphery of the compliant material 200 as the compliant material 200 is forced toward the nozzles of the ejection head 202. Hence, the dome shape compliant material 200 may be effective to minimize air pockets adjacent to the nozzles during shipment and storage of the ejection heads 202 and cartridge bodies 204.

The compliant material, as described herein, may be an elastomeric pad 200 derived from natural and/or synthetic rubber materials. Suitable natural and/or synthetic rubber materials may be selected from, but are not limited to, polyisoprene, styrene-butadiene, polystyrene, polymethylpentene, polybutylene, polyisobutylene, ethylene propylene diene monomer terpolymer, styrene butadiene styrene copolymer, styrene ethylene butylene copolymer, styrene isoprene styrene copolymer, polybutene-1, isobutylene rubber, methyl acrylate butadiene styrene copolymer, acrylonitrile butadiene styrene copolymer, acrylonitrile alkylacrylate butadiene styrene copolymer, methyl methacrylate alkyl acrylate styrene copolymer, and methyl methacrylate alkyl acrylate butadiene styrene copolymer.

The foregoing elastomeric pad 200 may be further characterized by a relatively low hardness and a relatively low roughness. The hardness of the pad 200 may range from about 10 to about 50 Shore A durometer as determined according to ASTM D2240 00, and the roughness may have a Ra (roughness number) according to ISO 1302 in the range of from about 1 to about 70 nm. Materials that are not chemically reactive with any of the fluids or ejection head components may provide suitable sealing materials. An example of an elastomeric material that may be particularly suitable is a natural of synthetic rubber material having a hardness of about 20 Shore A durometer, a Ra of about 30 nm, and a modulus of elasticity of about 100 N/cm² that increases with elongation. The elastomeric pad 200 may have a thickness ranging from about 1 to about 10 millimeters.

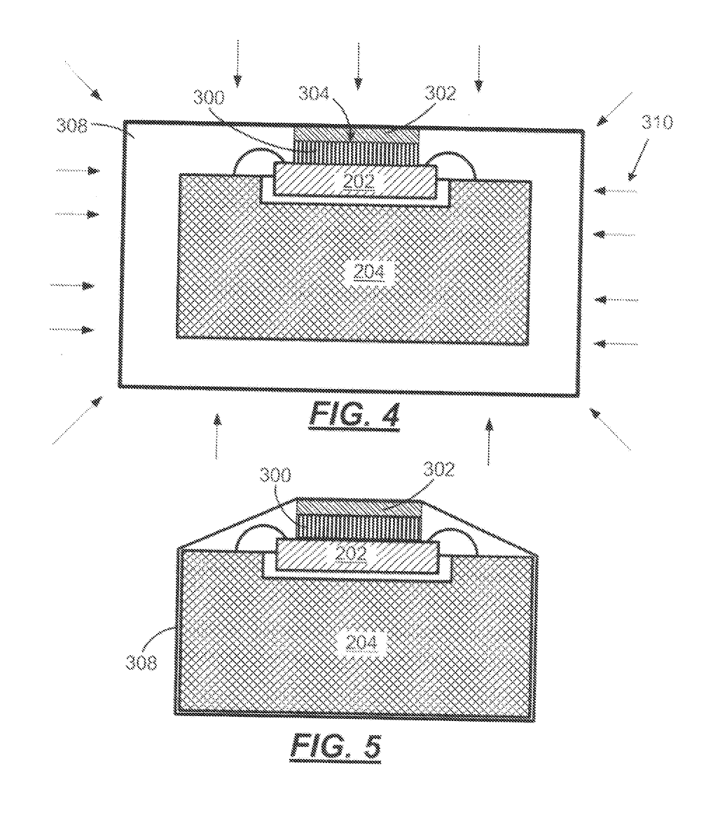

In another embodiment, illustrated in FIGS. 4 and 5, the compliant material includes an elastomeric pad 300 having and a relatively rigid backing material 302 adjacent to a side 304 of the pad opposite to a side adjacent to the ejection head 202. The relatively rigid backing material 302 may be made of a wide variety of materials, including, but not limited to, hard plastics, metal, paperboard, and the like. The relatively rigid backing material 302 may or may not be adhesively attached or otherwise affixed to the elastomeric pad 300. The purpose of the relatively rigid backing material 302 is to apply an essentially uniform force to the elastomeric pad 300 to effect a seal between the pad 300 and the nozzles of the ejection head 202. The thickness of the relatively rigid backing material 302 is not critical to the disclosed embodiments and may be any thickness suitable for providing the relatively rigid properties required by the hacking material. Accordingly, a particularly suitable backing material 302 is rigid polyethylene plaque having a thickness ranging from about 0.5 to about 5 millimeters.

With reference again to FIGS. 2-3, in order to apply a suitable sealing force to the elastomeric pad 200 sufficient to seal the nozzles on the ejection head 202, a removable shrink wrap film 208 is applied to the ejection head and compliant material 200. The shrink wrap film 208 may be in tubular form with the compliant material 200 attached thereto, or the compliant material 200 may be separately positioned adjacent the nozzle area of an ejection head 202 and the shrink wrap film 208 applied to both the compliant material 200 and the ejection head 202. Conventional shrinking plastic materials for the shrink wrap film 208 may include virgin low density polyethylene, (LDPE) or medium density polyethylene (MDPE), or a combination of LOPE or MDPE and a layer of amorphous plastic material or a mixture of amorphous plastic material and LDPE or MDPE which, when being shrank, does not stick to the ejection head.

The amorphous plastic material may be at least one of the following amorphous polymers: polyamide, polycarbonate, polymethyl methacrylate, polystyrene, polyvinyl chloride, polyisobutene, polypropene (atactic), polyethylene terephthalate, polyurethane, acrylic nitrile butadiene styrene, acrylic nitrile styrene acrylate, polyether imide, polysulphone, polyacrylate, and the like. It should be noted that polyethylene terephthalate polymer may be either amorphous or non-amorphous.

Heat-shrinkable films may also be made from a blend of styrene-butadiene copolymer resins and polyolefins. The polyolefins may be selected from one or more of the following types: very low molecular weight polyethylene (VLMWPE), low molecular weight polyethylene (LMWPE), high molecular weight polyethylene (HMWPE), MDPE, linear low density polyethylene (LLDPE), very low density polyethylene (VLDPE), LDPE, ultra low density polyethylene (ULDPE), high density polyethylene (HDPE), copolymers of ethylene (PE) with ethylene vinyl acetate (EVA), ethylene methyl acrylate (EMA), ethylene acrylic acid (EAA) or a mixture thereof. The film may also include any other olefinic material, such as polypropylene and their copolymers and terpolymers, linear or branched; butadiene and their copolymers, linear or branched; isoprene and their copolymers, linear or branched; ethylene-butene, ethylene-hexene, ethylene-octene copolymers and mixtures thereof. Other components of the shrink wrap film 208 may include pigments, antiblocking agents, slip agents, coloring agents, antioxidants, ultraviolet light absorbers, fillers or any other type of conventional additive.

The film 208 should have relatively low creep properties in order to resist movement of the film once the film 208 is shrunk onto the compliant material 200 and ejection head 202 as shown in FIG. 3. It has been discovered that suitable creep properties are achieved by use of films having a thickness of greater than about 0.01 millimeters. Accordingly, shrink wrap films having a thickness ranging from about 0.02 to about 0.1 millimeters are suitable for use in the disclosed embodiments.

Films 208 that may be shrunk by applying a temperature ranging from about 50°to about 120° C. are particularly suitable for providing a force to the compliant material 200 for sealing the nozzles of the ejection head 202. The film 208 should also be capable of applying a compressive force to the compliant material 200 that is sufficient to seal the nozzles.

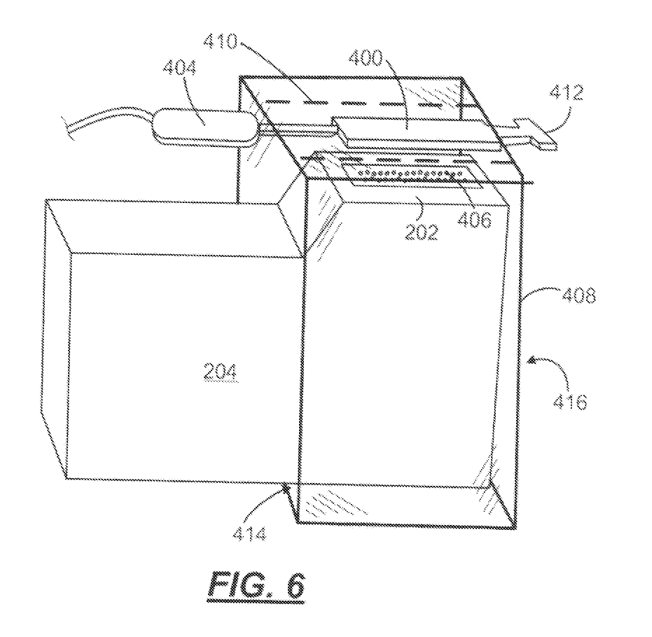

A first method of sealing nozzles of the ejection head 202 is illustrated in FIGS. 2-3. The tubular shrink wrap film 208 with attached dome-shaped compliant material 200 is positioned to surround at least a portion of the ejection head 202 as illustrated in FIG. 2 so that the compliant material 200 is adjacent to the nozzles. In yet another embodiment, illustrated in FIG. 6, a vacuum lance 404 may be used to align a compliant material 400 to nozzles 406 and to provide a temporary seal. Heat, represented by arrows 210 (FIG. 2), is then applied to the film 208 to cause the film to shrink and provide a force to the compliant material 200 to seal the nozzles as shown in FIG. 3.

Once the film has been shrunk, the vacuum lance 404 may be retracted from the ejection head 202. As shown in FIG. 6, it is desirable for the shrink wrap film 408 to include perforations 410 for easy removal of the film 408 and compliant material 400 from the ejection head 202 so that the ejection head 202 can be used. In another embodiment, described in more detail below, a tab 412 may be included with the compliant material 400 to aid in removing the film 408 and compliant material 400 from the ejection head 202 prior to use of the ejection head 202.

FIGS. 4 and 5 illustrate application of the compliant material 300 containing a relatively rigid backing material 302 and shrink wrap film 308 to the ejection head 202. In this embodiment, the relatively rigid backing material 302 holds the compliant material 300 in a substantially planar orientation for application to the ejection head 202. As with the previous embodiment, heat, indicated by arrows 310, is applied to the shrink wrap film 308 to shrink the film 308 and provide a compressive force to the compliant and backing materials 300/302 in order to seal the nozzles. The shrink wrap film 208, 308, and 408, in the illustrated embodiments is configured as a tubular material having open opposed sides 414 and 416 (FIG. 6) so that the film surrounds at least a portion of four sides of the cartridge body 204. However, the shrink wrap film may also be configured as a cup-shaped material having only one open side opposite a side attached to the compliant material so that the shrink wrap material only partially surrounds the cartridge body 204.

By way of a non-limiting example, a test was conducted to verify that the shrink wrap film, upon shrinking, will apply sufficient force to the compliant material to seal the nozzles. According to the example, a polyethylene terephthalate (PET) film having a thickness of 0.05 millimeters was shrunk over a pressure transducer, simulating the ejection head 202. The pressure transducer registered 2.3 kilogram-force of compression or sealing force. The force applied to the compliant material may be adjusted by sizing the shrink wrap film dimension relative to the ejection head. For example, a tightly fitted shrink wrap film tube or cup produces higher force than a loosely fitted shrink wrap film tube or cup. The flexibility of controlling the sealing force allows matching sealing force with sealing requirements thereby avoiding possible damage to the ejection head such as substrate cracks that may develop if too much force is applied to the ejection head 202.

In another example, fluid in an ejection head was pressurized with 7.3 psi which was equivalent to a 20,000 ft. altitude. Variable forces were applied on a compliant material sealing the nozzles on the ejection head. Results indicated a minimum force required to seal the nozzles without fluid leaking from the nozzles was 1.1 kilogram-force which is far below the shrink wrap film force indicated in the previous example. Elevated temperatures used to shrink the film are not a concern because data showed that the nozzle area was exposed to a maximum temperature of 55° C. during the shrinking process.

By providing the film as a continuous sleeve of material around the cartridge 202, shrinking the film not only provides the required compressive force for sealing the nozzles, but also rigidly binds the film and compliant material to the ejection head 202 so that the ejection head 202 can survive physical impacts such as dropping. In addition, the compliant sealing material may absorb impacts thereby preventing damage to the ejection head 202. Accordingly, nozzles of the ejection head may be sealed with only the compliant material and shrink wrap film without other materials and without additional machining of the ejection bead or sealing materials.

With reference again to FIG. 6, the compliant material 404 may also include a tab 412 attached thereto for assisting in removal of the film 408 from the cartridge body 204. The tab 412 extends through an open end of the film 408 so that the tab 412 is exposed upon shrinking of the film 408. By grabbing the tab 412 and lifting the compliant material 400 from the ejection head 202, the film 408 is caused to tear along the perforations 410 so that the film 408 and compliant material 400 may be removed from the ejection head 202 so that the ejection head 202 can be used.

It will be appreciated that since no adhesive components are required in order to effect sealing of the nozzles of the ejection head 202, the compliant material 200, 300, or 400 may be cleanly removed from the ejection bead 202 without resulting in adhesive residue that could clog the nozzles. Likewise, no adhesive is used with the shrink wrap film since the film itself provides compressive forces that compress the compliant material and 200, 300, or 400 and conform to the cartridge body 204 around a periphery of the cartridge body as described and illustrated above. Thus removal of the film 200, 300, or 400 also results in an absence of residue remaining on portions of the cartridge body 204 or ejection head 202.

Other embodiments of the present disclosure will be apparent to those skilled in the art from consideration of the specification and practice of the embodiments disclosed herein. As used throughout the specification, and claims, “a” and/or “an” may refer to one or more than one. Unless otherwise indicated, all numbers used in the specification and claims are to be understood as being modified in all instances by the term, “about.” Accordingly, unless indicated to the contrary, the numerical parameters set forth in the specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the invention being indicated by the following claims.

What is claimed is:

1. A compliant sealing structure suitable for sealing a micro-fluid ejection head, the sealing structure comprising:
an elastomeric pad suitable for sealing nozzles of the micro-fluid ejection head, and
a removable shrink wrap film configured for covering at least a portion of the elastomeric pad and for fixedly holding the elastomeric pad adjacent the nozzles.

2. The sealing structure of claim 1, wherein the elastomeric pad comprises a natural or synthetic rubber pad.

3. The sealing structure of claim 1, wherein the elastomeric pad has a thickness ranging from about 1 to about 10 millimeters.

4. The sealing structure of claim 1, wherein the elastomeric pad has a durometer ranging from about 10 to about 50 Shore A durometer.

5. The sealing structure of claim 1, wherein the shrink wrap film comprises a film selected from the group consisting of poly vinyl chloride, a polyolefin, a polyester, and a mixture of two or more of the foregoing.

6. The sealing structure of claim 1, wherein the shrink wrap film contains perforations for removal thereof.

7. The sealing structure of claim 1, wherein the elastomeric pad comprises a pad portion and a tab portion attached to the pad portion on one end thereof.

8. The sealing structure of claim 7, wherein at least a portion of the tab portion is not covered by the shrink wrap film.

9. The sealing structure of claim 1, wherein the elastomeric pad has a dome shape.

10. The sealing structure of claim 1, wherein the elastomeric pad comprises a compliant pad portion and a substantially rigid backing portion.

11. A micro-fluid ejection head comprising the sealing structure of claim 1.

12. A method of sealing a nozzle area containing nozzles on a micro-fluid ejection head with a removable sealing member comprising:
applying a compliant pad to the nozzle area; and
shrink wrapping the micro-fluid ejection head and at least a portion of the compliant pad with a removable shrink wrap film.

13. The method according to claim 12, wherein the elastomeric pad comprises a natural or synthetic rubber pad.

14. The method according to claim 12, wherein the elastomeric pad has a thickness ranging from about 1 to about 10 millimeters.

15. The method according to claim 12, wherein the elastomeric pad has a durometer ranging from about 10 to about 50 Shore A durometer.

16. The method according to claim 12, wherein the shrink wrap film comprises a film selected from the group consisting of poly vinyl chloride, a polyolefin, a polyester, and a mixture of two or more of the foregoing.

17. The method according to claim 12, wherein the shrink wrap film contains perforations for removal thereof.

18. The method according to claim 12, wherein the elastomeric pad comprises a pad portion and a tab portion attached to the pad portion on one end thereof.

19. The method according to claim 18, wherein at least a portion of the tab portion is not covered by the shrink wrap film.

20. The method according to claim 12, wherein the elastomeric pad has a dome shape, further comprising depressing the dome shaped pad to the nozzle area while shrink wrapping the ejecting head.

21. The method according to claim 12, wherein the elastomeric pad comprises a compliant pad portion and a substantially rigid backing portion.

22. The method according to claim 12, wherein the shrink wrap film applies a pressure during the shrink wrapping step to the compliant pad that is suitable to effectively seal the nozzle area of the ejection bead.

23. The method according to claim 22, wherein the pressure ranges from about 0.05 to about 5.0 kilogram-force.

24. A micro-fluid ejection head comprising a nozzle area sealed by the method of claim 12.
